(19) United States
(12) Patent Application Publication
(10) Pub. No.: US 2020/0026917 A1
(43) Pub. Date: Jan. 23, 2020

(54) AUTHENTICATION METHOD, APPARATUS AND SYSTEM

(71) Applicant: BEIJING 7INVENSUN TECHNOLOGY CO., LTD., Beijing (CN)

(72) Inventors: Linchan QIN, Beijing (CN); Wenkai HUANG, Beijing (CN)

(73) Assignee: BEIJING 7INVENSUN TECHNOLOGY CO., LTD., Beijing (CN)

(21) Appl. No.: 16/338,377

(22) PCT Filed: Mar. 28, 2018
(86) PCT No.: PCT/CN2018/080812

§ 371 Date: Mar. 29, 2019

(30) Foreign Application Priority Data
Mar. 30, 2017 (CN) 201710203221.2

(51) Int. Cl. G06K 9/00; G06F 21/32; G06F 3/01; H04L 29/06

(52) U.S. Cl. CPC G06K 9/00597; G06F 21/32; G06K 9/00255; H04L 63/0861; G06F 3/013

(57) ABSTRACT

A method, an apparatus and system for authentication are provided. The method includes: acquiring, on reception of an authentication request sent by a terminal, target point information, and sending the target point information to the terminal, so that the terminal displays a position point to be gazed at by a user on a screen base on the target point information; receiving first eye information acquired by the terminal when the user gazes at the position point; and performing identity authentication on the user based on the first eye information and the target point information. With the method, the apparatus, and the system for authentication, identify authentication is performed based on the eye information and the coordinates of the position point, so as to verify the iris, increase the security of payment and confirm the pay willingness of the user.

### FIELD

The present disclosure relates to the technical field of authentication, and in particular to a method, an apparatus and a system for authentication.

### BACKGROUND

With the popularity of mobile terminals, more and more users make payments through mobile terminals during shopping or other occasions. When a user makes a payment using the mobile terminal, the user needs confirm the payment amount and input an authentication password on the mobile terminal, to complete the payment, where the password is used for performing identify authentication on the user. In addition, when the user is to log into a system or an application, the user is also required to input a password for identity authentication.

In scenarios where a password is required for authentication, it often happens that the user forgets the password, which leads to an authentication failure. In order to solve the problem, in the conventional technology, recognition of biometric features, such as fingerprints, voices and irises is introduced, in which case payment is performed when the biometric feature authentication is successful. Among authentication methods based on biometric feature recognition, iris recognition is preferred due to its high recognition accuracy and better anti-counterfeiting performance. However, like the fingerprint recognition and the voice recognition in which static fingerprints, audio recordings are used for cheating in authentication, iris pictures, or a film attached on a human eyeball is used to cheat in authentication based on iris recognition. In addition, in a scenario where payment is performed based on iris recognition, it is necessary to confirm the payment willingness of the user, so as to avoid the deductions when a user is led to watch a device equipped with iris recognition function and iris recognition is performed.

Therefore, an issue to be solved is to verify an iris of a user, so as to improve the security of payment, and confirm the payment willingness of the user.

### SUMMARY

In view of this, a method, an apparatus, and a system for authentication are provided according to the embodiments of the present disclosure to verify an iris of a user, so as to improve the security of payment, and confirm the pay willingness of the user.

In a first aspect, a method for authentication is provided, which includes: acquiring, on reception of an authentication request sent by a terminal, target point information, and sending the target point information to the terminal, so that the terminal displays a position point to be gazed at by a user on a screen base on the target point information; receiving first eye information acquired by the terminal when the user gazes at the position point; and performing identity authentication on the user based on the first eye information and the target point information.

In combination with the first aspect, a first possible implementation of the above first aspect is provided according to an embodiment of the present disclosure, where in a case that the first eye information is a first eye image, the performing identity authentication on the user based on the first eye information and the target point information includes: extracting an eye movement feature and a first iris feature from the first eye information, querying a database to determine whether the first iris feature is stored in the database, acquiring, in a case of determining that the first iris feature is stored in the database, a stored eye movement calibration coefficient matching the first iris feature, where the eye movement calibration coefficient is obtained when a real user registers for an account, and is used for calibrating an eye movement feature of a user using the account, and determining a result of the identity authentication performed on the user based on the eye movement calibration coefficient, the eye movement feature and the target point information.

In combination with the first aspect, a second possible implementation of the above first aspect is provided according to an embodiment of the present disclosure, where in a case that the first eye information is a first eye image and the authentication request carries user account information, the performing identity authentication on the user based on the first eye information and the target point information includes: extracting an eye movement feature and a first iris feature from the first eye information, acquiring a stored second iris feature corresponding to the user account information, and determining whether the second iris feature matches the first iris feature, acquiring, in a case of determining that the second iris feature matches the first iris feature, a stored eye movement calibration coefficient matching the first iris feature, where the eye movement calibration coefficient is obtained when a real user registers for an account, and is used for calibrating an eye movement feature of a user using the account, and determining a result of the identity authentication performed on the user based on the eye movement calibration coefficient, the eye movement feature and the target point information.

In combination with the first aspect, a third possible implementation of the above first aspect is provided according to an embodiment of the present disclosure, where in a case that the first eye information includes a first iris feature and an eye movement feature, the performing identity authentication on the user based on the first eye information and the target point information includes: querying a database to determine whether the first iris feature is stored in the database, acquiring, in a case of determining that the first iris feature is stored in the database, a stored eye movement calibration coefficient matching the first iris feature, where the eye movement calibration coefficient is obtained when a real user registers for an account, and is used for calibrating an eye movement feature of a user using the account, and determining a result of the identity authentication performed on the user based on the eye movement calibration coefficient, the eye movement feature and the target point information.

In combination with the first aspect, a fourth possible implementation of the above first aspect is provided according to an embodiment of the present disclosure, where the authentication request carries second eye information of the user, and in a case that the second eye information is a second eye image, the acquiring target point information includes: extracting a third iris feature from the second eye information, querying a database to determine whether the third iris feature is stored in the database, and acquiring, in a case of determining that the third iris feature is stored in the database, the target point information.

In combination with the fourth implementation of the first aspect, a fifth possible implementation of the above first aspect is provided according to an embodiment of the present disclosure, where the acquiring the target point information includes: selecting at least one feature value from the third iris feature, where the third iris feature includes multiple feature values, calculating coordinate values of a target point based on the at least one feature value according to a preset rule, and determining the coordinate values of the target point as the target point information.

In combination with the fourth implementation of the first aspect, a sixth possible implementation of the above first aspect is provided according to an embodiment of the present disclosure, where the method further includes: sending, in a case of determining that the third iris feature is not stored in the database, prompt information to the terminal to instruct the terminal to prompt the user to register; and recording, on reception of a registration request sent by the terminal, the iris feature and the eye movement calibration coefficient of the user.

In a second aspect, a method for authentication is provided according to an embodiment of the present disclosure, which includes: sending an authentication request to a server; receiving target point information sent by the server, and displaying a target point based on the target point information; and acquiring eye information when a user gazes at the target point, and sending the eye information to the server, where the eye information is used by the server for performing identify authentication on the user.

In combination with the second aspect, a first possible implementation of the above second aspect is provided according to an embodiment of the present disclosure, where the displaying a target point based on the target point information includes: determining a position of the target point on a display screen based on a coordinate origin of the display screen and the target point information, and displaying the target point at the position on the display screen.

In a third aspect, an apparatus for authentication is provided according to an embodiment of the present disclosure, which includes a sending module, a receiving module, and an authenticating module.

The sending module is configured to acquire, on reception of an authentication request sent by a terminal, target point information, and send the target point information to the terminal, so that the terminal displays a position point to be gazed at by a user on a screen base on the target point information.

The receiving module is configured to receive first eye information acquired by the terminal when the user gazes at the position point.

The authenticating module is configured to perform identity authentication on the user based on the first eye information and the target point information.

In combination with the third aspect, a first possible implementation of the above third aspect is provided according to an embodiment of the present disclosure, where in a case that the first eye information is a first eye image, the authenticating module includes a first extracting unit, a first querying unit, a first acquiring unit, and a first acquiring unit.

The first extracting unit is configured to extract an eye movement feature and a first iris feature from the first eye image.

The first querying unit is configured to query a database to determine whether the first iris feature is stored in the database.

The first acquiring unit is configured to acquire, in a case of determining that the first iris feature is stored in the database, a stored eye movement calibration coefficient matching the first iris feature, where the eye movement calibration coefficient is obtained when a real user registers for an account, and is used for calibrating an eye movement feature of a user using the account.

The first determining unit is configured to determine a result of the identity authentication performed on the user based on the eye movement calibration coefficient, the eye movement feature and the target point information.

In combination with the third aspect, a second possible implementation of the above third aspect is provided according to an embodiment of the present disclosure, where the authentication request carries second eye information of the user, and in a case that the second eye information is a second eye image, the sending module includes: a second extracting unit, a second querying unit, and a sending unit.

The second extracting unit is configured to extract a third iris feature from the second eye information,

The second querying unit is configured to query a database to determine whether the third iris feature is stored in the database, and

The sending unit is configured to acquire, in a case of determining that the third iris feature is stored in the database, the target point information.

In a fourth aspect, an apparatus for authentication is provided according to an embodiment of the present disclosure, which includes a sending module, a receiving module, and an acquiring module.

The sending module is configured to send an authentication request to a server;

The receiving module is configured to receive target point information sent by the server and display a target point based on the target point information; and

The acquiring module is configured to acquire eye information when a user gazes at the target point, and send the eye information to the server, where the eye information is used by the server for performing identify authentication on the user.

In a fifth aspect, a system for authentication is provided, which includes an authentication server and an authentication terminal, where the authentication server includes the apparatus for authentication of the third aspect, and the authentication terminal includes the apparatus for authentication of the fourth aspect.

With the method, the apparatus, and the system for authentication according to the embodiments of the present disclosure, identify authentication is performed on a user based on the eye information acquired when the user gazes at a position point on the screen, and the coordinates of the position point, so as to verify the iris, increase the security of payment and confirm the pay willingness of the user.

To make the above object, features and advantages of the present disclosure more apparent and easier to be understood, particular embodiments of the disclosure are illustrated in detail in conjunction with the drawings hereinafter.

### BRIEF DESCRIPTION OF THE DRAWINGS

The drawings to be used in the description of the embodiments or the conventional technology are described briefly as follows, so that the technical solutions according to the embodiments of the present disclosure or according to the conventional technology become clearer. It is apparent that the drawings in the following description only illustrate some embodiments of the present disclosure, and are not intended to limit the present disclosure. For those skilled in the art, other drawings may be obtained according to these drawings without any creative work.

FIG. 1 illustrates a flowchart of a first method for authentication according to an embodiment of the present disclosure;

FIG. 2 illustrates a flowchart of performing identity authentication on a user in the first method for authentication according to an embodiment of the present disclosure;

FIG. 3 illustrates a flowchart of a second method for authentication according to an embodiment of the present disclosure;

FIG. 4 illustrates a schematic structural diagram of a first apparatus for authentication according to an embodiment of the present disclosure;

FIG. 5 illustrates a schematic structural diagram of a first apparatus for authentication according to another embodiment of the present disclosure;

FIG. 6 illustrates a schematic structural diagram of a second apparatus for authentication according to an embodiment of the present disclosure; and

FIG. 7 illustrates a schematic structural diagram of a system for authentication according to an embodiment of the present disclosure.

### DETAILED DESCRIPTION OF EMBODIMENTS

In order to make the object, the technical solutions, and the advantages of embodiments of the present disclosure more clear, the technical solutions in the embodiments of the present disclosure are clearly and completely described hereinafter in conjunction with the drawings in the embodiments of the present disclosure. Apparently, the described embodiments are only a few rather than all of the embodiments of the present disclosure. The components of the embodiments of the present disclosure, which are generally described and illustrated in drawings herein, may be arranged and designed in various different configurations. Therefore, the following detailed description of the embodiments of the present disclosure provided in drawings are not intended to limit the protection scope of the present disclosure, but merely represents the selected embodiments of the present disclosure. All the other embodiments obtained by those skilled in the art based on the embodiments in the present disclosure without any creative work fall into the scope of the present disclosure.

The embodiments of the present disclosure are described by taking the payment scenario where payment authentication is performed in a physical store as an example. In this payment scenario, cashes are gradually replaced first by various types of bank cards, shopping mall cards, and bus cards, and then by mobile payment methods such as WeChat payment and Alipay payment. In the past two years. Mobile payment becomes more and more popular. In most cases of such cashless payment, the payers need to be authenticated and the pay willingness of the payers needs to be confirmed.

Although the conventional cashless payment is more convenient and hygienic than cash payment, there are often problems such as forgetting the card, the mobile phone, or the trade password, or operations that are difficult for an elderly person. In order to achieve smarter, safer and more convenient transactions, biometric feature recognition, such as fingerprint recognition, voice recognition, and iris recognition, is gradually adopted in identity authentication, in which case payment is performed when the biometric feature authentication is successful. Among authentication methods based on biometric feature recognition, iris recognition is preferred due to its high recognition accuracy and better anti-counterfeiting performance. However, like the fingerprint recognition and the voice recognition in which static fingerprints, audio recordings are used for cheating in authentication, iris pictures, or a film attached on a human eyeball is used to cheat in authentication based on iris recognition. In addition, in a scenario where payment is performed based on iris recognition, it is necessary to confirm the payment willingness of the user, so as to avoid the deductions when a user is led to watch a device equipped with iris recognition function and iris recognition is performed. Therefore, an issue to be solved is to verify an iris of a user, so as to improve the security of payment, and confirm the payment willingness of the user. In view of this, a method, an apparatus, and a system for authentication are provided according to the embodiments of the present disclosure, and are described in the following embodiments.

Optionally, the user is required to register before authentication is performed by using the method according the embodiments of the present disclosure. During the registration, an iris feature and an eye movement calibration coefficient of the user are recorded by the following procedure.

First, the user sends a registration request to a server through a terminal, where the registration request carries a terminal identifier of the terminal. When the server receives the registration request sent by the user through the terminal, the server sends information of a specific point to the terminal, where the information includes coordinate values of the specific point on a screen. When the terminal receives the information of the specific point sent by the server, the terminal displays the specific point on the screen based on the information. The specific point may include five points including four points on four corners of the screen and a point at the center of the screen. Alternatively, the specific point may include nine points including four points on four corners, midpoints of four sides, and the point at the center of the screen, or may be specific points at other positions on the screen. The above specific points are recorded as calibration points. The above are only examples for illustrating the specific point, and do not intend to limit the position of the specific point.

In an embodiment of the present disclosure, the server may sequentially send information of the specific points to the terminal in chronological order. The user is required to gaze at a calibration point on the screen when the terminal displays the specific points on the screen based on the specific point information. Then, a camera on the terminal collects an image of an eye of the user (hereinafter referred to as an eye image) when the user gazes at the calibration point, and sends the collected eye image to the server. The server extracts the iris feature of the user and the eye movement feature of the user when the user gazes at the calibration point from the received eye image. Alternatively, the terminal extracts the iris feature of the user and the eye movement feature of the user when the user gazes at the calibration point from the received eye image and sends the extracted iris feature and the extracted eye movement feature to the server.

The above iris feature includes, but is not limited to, a spot, a filament, a shape on the coronary plane, a stripe, a crypt of an eye. The eye movement feature refers to eye features of the user when the user gazes at the calibration point, including but not limited to an eye corner, a position of a center of a pupil, a radius of the pupil, and a Purkinje spot formed by corneal reflection.

After the iris feature and the eye movement feature are extracted from the eye image, a calibration coefficient of the user is calculated based on the eye movement feature of the user when the user gazes at the calibration point and the coordinate information of the calibration point. The calibration coefficient of the user includes but is not limited to an angle between a visual axis and an optical axis, or other eye features of the user.

After the iris feature and the calibration coefficient of the user are acquired, the iris feature and the calibration coefficient of the user are associated with the payment information of the user. The payment information includes but is not limited to a bank account, a third-party payment platform, and an account created for the payment manner. The iris feature, the calibration coefficient and the payment information are stored in the database. In addition, the iris feature of the user may be associated with the identity information of the user, for example, an ID card of the user.

The above authentication account information further includes a registered account, a password set by the user, a linked bank card and an authentication manner, and the like.

The method for authentication according to the embodiment of the present disclosure may be used for authentication during a payment, and may be used for identity authentication when the user logs into an account of a system or an application. The application field of the above authentication is not limited in the embodiment of the present disclosure.

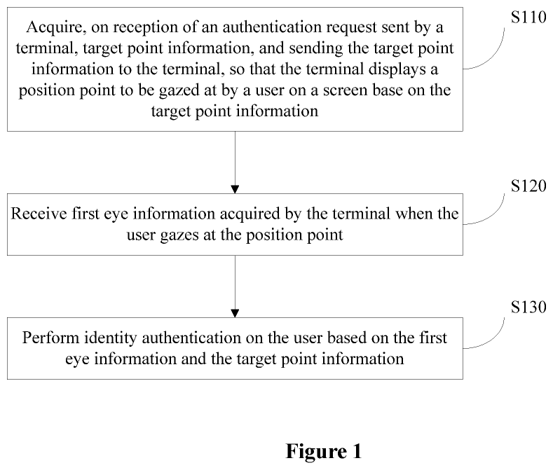

Referring to FIG. 1, a first method for authentication is provided according to an embodiment of the present disclosure. The method is performed by a server, and includes the following steps S110 to S130.

In step S110, on reception of an authentication request sent by a terminal, target point information is acquired, and the target point information is sent to the terminal, so that the terminal displays a position point to be gazed at by a user on a screen based on the target point information.

The above terminal may be a computer, a cell phone, or a tablet computer. The terminal may be a user terminal, or may be a terminal used by a cashier for checkout.

In a case that the above method for authentication is used in the field of payment, the above authentication request may carry a payment amount and an identifier of the terminal that sends the authentication request. The identifier of the terminal may be a unique code (for example, the Identity, ID) of the terminal, an Internet Protocol (IP) address of the terminal, or the like.

In an embodiment, when the terminal sends the authentication request to the server, the cashier inputs the payment amount confirmed by the user into the terminal. The payment amount and the terminal identifier are included in the authentication request, which is sent to the server.

The above target point information includes coordinates of the target point on the screen of the terminal. The target point may be a point, a number, a letter or a geometric figure. Alternatively, the target point information may be multiple numbers, letters or symbols, which represent a button on the keyboard of the terminal. The above target point information may be the position of the target point to be gazed at by the user on a keyboard, for example, in a row and a column of the keyboard.

When the user gazes at the target point displayed on the display screen, the brightness of the gazed point may continuously change during the gazing of the user. For example, the gazed point may be gradually brightened or gradually dimmed. The gazed point on the screen disappears after the user completes one recognition.

Optionally, the server sends the target point information to the terminal in the following two manners.

In a first manner, the server sends one piece of target point information to the terminal.

In this case, identity authentication is performed on the user only once. If the authentication is successful, the user is authenticated.

In a second manner, the server sequentially sends two or more pieces of target point information to the terminal in chronological order.

In this case, the user needs to successively gaze at multiple target points, and multiple identity authentications are performed on the user. In a case that the multiple authentications on the user are successful, the user is authenticated.

In the case that the server sequentially sends two or more pieces of target point information to the terminal in chronological order, these pieces of target point information may form a gaze track, and the user needs to gaze and recognize the gaze track.

In addition, the above authentication request may carry second eye information of the user.

In a case that the second eye information is a second eye image, the server acquiring the target point information includes:
extracting a third iris feature from the second eye information;
querying a database to determine whether the third iris feature is stored in the database; and
sending, in a case of determining that the third iris feature is stored in the database, the target point information to the terminal.

Optionally, the second eye information is acquired by capturing an image of an eye of the user through the terminal before the authentication request is sent to the server.

The extracting the third iris feature from the second eye image may include the following steps. First, it is determined whether the second eye image includes an eye region of the user. In a case that the second eye image does not include the eye region of the user, the possible reason may be that the eyes of the user are not aligned with the image collection device of the terminal when the second eye image of the user is collected by using the terminal. In this case, the server sends a prompt message to the terminal to prompt the terminal to reacquire the second eye image of the user. In a case that the second eye image includes the eye region of the user, the third iris feature of the user is extracted from the second eye image.

When the third iris feature of the user is extracted from the second eye image, a gray-scale image of the second eye image may be acquired first, and then at least one convolution process is performed on gray values of pixels in the above gray-scale image, so as to acquire the third iris feature of the user.

The above-described acquisition of the gray-scale image of the second eye image and the convolution processing are conventional technologies, and therefore, the specific processing procedure is not described herein.

In an embodiment, the third iris feature includes but is not limited to a spot, a filament, a shape on the coronary plane, a crypt of an eye.

In the embodiment of the present disclosure, the above database is pre-established, where the identity information, the iris feature, the calibration coefficient, the authentication account information of a registered user, and the correspondence between the identity information, the iris feature, the calibration coefficient, and the authentication account information of the registered user are stored in the database.

After the third iris feature is extracted from the second eye image, the database is queried, according to the third iris feature, to determine whether an iris feature that is consistent with the third iris feature is stored in the database. If the iris feature that is consistent with the third iris feature is stored in the database, it is indicated that the third iris feature is stored in the database and the user is a registered user. In this case, the following steps are performed to obtain the target point information.

In addition, the second eye information may also be a third iris feature, that is, the terminal extracts the iris feature of the user from the second eye image after collecting the second eye image of the user, and records the iris feature as a third iris feature. In this case, the third iris feature is determined as the second eye information, and the second eye information is included into the authentication request and is sent to the server. On reception the authentication request from the terminal, the server queries the data base to determine whether the third iris feature in the above authentication request is stored in the database. In a case that the third iris feature is stored in the database, the user corresponding to the third iris feature is a registered user. Then, the target point information is acquired.

The server may acquire the target point information in the following manners.

The server selects at least one feature value from the third iris feature, where the third iris feature includes multiple feature values. The server calculates coordinate values of a target point based on the at least one feature value according to a preset rule. The server determines the coordinate values of the target point as the target point information.

In the embodiment of the present disclosure, iris features such as the spot, the filament, the shape on the coronary plane and the stripe are characterized by feature values, that is, the iris feature includes multiple feature values. Therefore, any one, two, three or more feature values of the third iris feature may be randomly selected, and the coordinate values of the target point are calculated based on the selected feature values according to the preset rule.

Optionally, the preset rule may be addition, subtraction, multiplication and division between the feature values, may be addition, subtraction, multiplication and division on the basis of the feature values, or may be addition, subtraction, multiplication and division between current time information, a payment serial number of the user, and the acquired feature values. The preset rule may be other operations, which are not limited by the embodiments of the present disclosure.

If one feature value is selected, the feature value may be separated into two values according to a preset rule, and the two values are determined as the coordinates of the target point. For example, the selected feature value is 1.234, then two halves of 1.234 may be used as two coordinate values, that is, the determined coordinate values are 0.617 and 0.617. As another example, one third of 1.234 may be used as one coordinate value, and two thirds of 1.234 may be used as another coordinate value. As another example, the numbers 1, 2, 3, and 4 in 1.234 are randomly combined to determine two coordinate values. Certainly, other methods are also acceptable. In a case that two feature values are selected, the selected two feature values can be processed respectively according to the preset rule. For example, the current time is added to each of the two feature values. As another example, the current time is added to one feature value, and the current time is subtracted from the other feature value. Alternatively, two coordinate values may be determined by different operations between two feature values. In a case that three or more feature values are selected, the coordinates of the target point is determined by using an operation among the feature values according to the preset rule.

The coordinate values of the target point is determined based on the at least two feature values according to the preset rule. Optionally, the coordinate values of the target point are two numerical values, and the server determines the calculated coordinate values of the target point as the target point information and sends the target point information to the server.

In addition, the above server may acquire the target point information in the following manners:

1) in a case that multiple pieces of target point information are stored in the database of the server, and when the authentication request sent by the terminal is received by the server, the server randomly acquires target point information from the database;

2) in a case that multiple pieces of preset target point information corresponding to each iris feature are stored in the database of the server, and when the authentication request sent by the terminal is received by the server, the server extracts the iris feature of the user from the eye image carried in the authentication request, and acquires target point information corresponding to the iris feature from the database according to the iris feature;

3) in a case that no target point information is stored in the server, and when the authentication request sent by the terminal is received by the server, the target point information is randomly generated.

After the server acquires the target point information in any one of the above manners, the server sends the target point information to the terminal according to the identifier of the terminal.

In addition, in a case that the third iris feature is not found in the database, the following steps are performed:
sending, in a case of determining that the third iris feature is not stored in the database, prompt information to the terminal to instruct the terminal to prompt the user to register; and
recording, on reception of a registration request sent by the terminal, the iris feature and the eye movement calibration coefficient of the user.

In a case that the iris feature that is consistent with the third iris feature is not found in the above database, the third iris feature is not stored in the database, and the user is an unregistered user. In this case, the server sends a prompt message to the terminal to instruct the terminal to prompt the user to register. When the terminal receives the prompt message sent by the server, the terminal prompts the user to register by voice or by text. In a case that the user determines to register. When the server receives the registration request sent by the user through the terminal, the server sends the calibration point information to the terminal for acquiring the iris feature and the eye movement calibration coefficient of the user. Certainly, the registration account information and the identity information of the user are also required.

In step S120, the first eye information collected by the terminal when the user gazes at the location point is received.

When the terminal receives the target point information sent by the server, the target point is displayed at a corresponding position on the screen based on the target point information, that is, the position point to be gazed at by the user is determined, and the first eye image of the user is collected when the user gazes at the position point on the screen. Then, the collected first eye image is sent to the server as the first eye information.

In addition, the terminal may extract the first iris feature and the eye movement feature from the first eye image after collecting the first eye image of the user, and sends the extracted first iris feature and the extracted eye movement feature to the server as the first eye information. The server performs identify authentication on the user based on the received first eye information.

In step S130, identity authentication is performed on the user based on the first eye information and the target point information.

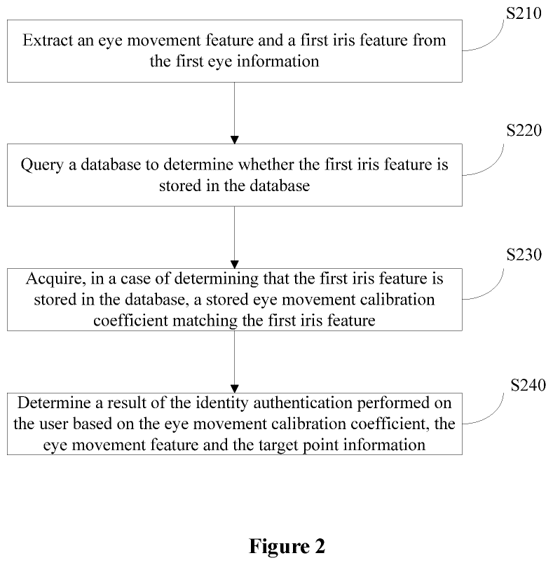

In a case that the first eye information is the first eye image, referring to FIG. 2, the above performing identity authentication on the user based on the first eye information and the target point information includes the following steps S210 to S240.

In step S210, an eye movement feature and a first iris feature are extracted from the first eye image.

In step S220, a database is queried to determine whether the first iris feature is stored in the data base.

In step S230, in a case of determining that the first iris feature is stored in the database, a stored eye movement calibration coefficient matching the first iris feature is acquired, where the eye movement calibration coefficient is obtained when a real user registers for an account, and is used for calibrating an eye movement feature of a user using the account.

In step S240, a result of the identity authentication performed on the user is determined based on the eye movement calibration coefficient, the eye movement feature and the target point information.

The above eye movement features refer to the position of the center of the pupil, the radius of the pupil, the eye corner, and the Purkinje spot formed by the corneal reflection when the user gazes at the position point. The process of extracting the eye movement feature and the first iris feature from the first eye image in step S210 is the same as the process of extracting the third iris feature in step S110. Therefore, the above extracting process is not described in detail herein.

In the above step S220, first, the database is queried to determine whether the first iris feature is stored in the database. If the first iris feature is stored in the database, it is indicated that recognition of the iris of the user is successful. However, in this case, there may be possibilities that a film is attached on the eyeball of the user or the user is induced to gaze or unintentionally gases at the iris recognition device. Therefore, a further authentication on the identity of the user is required.

In a case that the iris recognition in step S220 is successful, the eye movement calibration coefficient corresponding to the first iris feature is acquired from the database, and the eye movement calibration coefficient is determined as the eye movement calibration coefficient of the user. The above calibration coefficient refers to an angle between a visual axis and an optical axis of the user. The angle between the visual axis and the optical axis of the eye of the user is constant when the user gazes at different points on the screen.

Optionally, in the above step S240, the determining the result of the identity authentication performed on the user based on the eye movement feature, the eye movement calibration coefficient and the target point information includes the following two cases.

In a first case, theoretical gazing point coordinates when the user gazes at the position point on the screen are calculated based on the eye movement feature and the eye movement calibration coefficient. The theoretical gazing point coordinates are compared with the coordinates of the target point in the target point information. In a case that the above theoretical gazing point falls within a range around the target point for a time period, the above target point recognition is successful. In a case that the user is required to identify only one position point, it can be determined that the user is a living user, and the identity authentication performed on the user is successful. In a case that the user is required to gaze at multiple position points successively, after the first position point is successfully recognized, a second position point is displayed on the screen until the multiple position points that the user is required to gaze at are successfully identified. At this time, the user can be determined to be a living user, that is, the identity authentication on the user is successful.

Generally, the above time period may be 200 ms.

In a second case, the eye movement calibration coefficient of the user is calculated based on the eye movement feature and coordinates of the target point in the target point information, and the calculated eye movement calibration coefficient is compared with the eye movement calibration coefficient acquired from the database. If the difference is within an error allowance range, it is determined that the calculated eye movement calibration coefficient and the acquired eye movement calibration coefficient are consistent with each other, which indicates that the position point is successfully recognized. In a case that the user is required to gaze at only one position point, the user can be determined as a living user, that is, the identity authentication on the user is successful. In a case that the user is required to gaze at multiple positions successively, after the first position point is successfully recognized, the screen displays the second position point. At this time, the user is required to gaze at the second position point, that is, the second position point is recognized until the multiple position points to be gazed at by the user are successfully recognized. At this time, the user can be determined as a living user, that is, the identity authentication on the user is successful.

In a case that the first eye information is the first eye image, and the authentication request carries user account information, the identify authentication may be performed on the user in the following manner.

An eye movement feature and a first iris feature are extracted from the first eye image. A stored second iris feature corresponding to the user account information is acquired, and it is determined whether the second iris feature matches the first iris feature. If the second iris feature matches the first iris feature, a stored eye movement calibration coefficient matching the first iris feature is acquired, where the eye movement calibration coefficient is obtained when a real user registers for an account, and is used for calibrating an eye movement feature of a user using the account. A result of the identity authentication performed on the user is determined based on the eye movement calibration coefficient, the eye movement feature and the target point information.

In the above process, first, the database is queried based on the user account information to find the second iris feature corresponding to the user account information, and then it is determined whether the iris feature matches the first iris feature. If the iris feature does not match the first iris feature, it is indicated that the user corresponding to the first iris feature is not the user corresponding to the account information. In this case, the authentication fails. If the first iris feature matches the second iris feature, it indicates that the user corresponding to the first iris feature is the user corresponding to the account information. In this case, it is determined that the iris recognition of the user is successful. However, in this case, there is still a possibility that a film is attached on the eyeball of the user. Therefore, the identity of the user needs to be further authenticated.

In a case that the first eye information includes the first iris feature and the eye movement feature, that is, the terminal sends the first iris feature and the eye movement feature extracted from the collected first eye image to the server, the identify authentication is performed on the user based on the first eye information and the target point information, which includes:
querying a database to determine whether the first iris feature is stored in the database; acquiring, in a case of determining that the first iris feature is stored in the database, an stored eye movement calibration coefficient matching the first iris feature, where the eye movement calibration coefficient is obtained when a real user registers for an account, and is used for calibrating an eye movement feature of a user using the account; and determining a result of the identity authentication performed on the user based on the eye movement calibration coefficient, the eye movement feature and the target point information.

The above authentication process is similar to the authentication process in the case of the first eye information including the first eye image, and is not described in detail herein.

No matter whether the second eye information is carried in the above authentication request, an identity authentication can be performed on the user through the above method. In addition, in a case that the second eye information is carried in the authentication request, the identity authentication can also be performed on the user in the following manner.

In a case that the second eye information is carried in the authentication request, the server queries the database to find a third iris feature corresponding to the second eye information, and in a case of determining that the third iris feature is stored in the database, the server directly acquires the eye movement calibration coefficient corresponding to the third iris feature, so as to perform subsequent identity authentication using the eye movement calibration coefficient. In this case, during subsequent identity authentication, it is unnecessary to perform the iris recognition based on the first iris feature corresponding to the received first eye information to find the eye movement calibration coefficient, and identity authentication may be performed in the following three manners. 1) In a case that the first eye information is the first eye image, the service extracts only the eye movement feature from the first eye information, and performs identity authentication on the user based on the acquired eye movement calibration coefficient, the eye movement feature, and the target point information. 2) In a case that the first eye information is the first eye image, the eye movement feature is extracted from the first eye information, and the second iris feature corresponding to the user account information is acquired from the database, it is determined whether the second iris feature matches the third iris feature to determine whether the user corresponding to the third iris feature is consistent with the user corresponding to the account information, and if the user corresponding to the third iris feature is consistent with the user corresponding to the account information, the identity authentication is performed on the user based on the acquired eye movement calibration coefficient, the eye movement feature and the target point information. 3) In a case that the first eye information acquired by the terminal includes only the eye movement feature, the identity authentication is performed based on the eye movement feature, the eye movement calibration coefficient acquired based on the third iris feature, and the target point information.

In the embodiment of the present disclosure, in a case that the above method for authentication is applied in payment, the user is allowed to make a payment only when the user identity authentication is successful. In a case that the above method for authentication is applied when a user logs into an application or a system, the user is allowed to log in only when the user identity authentication is successful.

In a case that the above method for authentication is applied in the payment scenario, when the user identity authentication is successful, a payment manner selected by the user is to be acquired, and the payment is performed in the selected payment manner.

The user presets multiple payment manners during registration, or may add other payment manners subsequently. Optionally, the above payment manners include, but are not limited to, bank card payment, credit card payment, and third-party platform payment.

In addition, in an embodiment of the present disclosure, the payment authentication may be performed in the following manners.

After confirming the payment amount with the cashier, and before the payment request is submitted to the server, the user needs to input a password. In an embodiment of the present disclosure, the user inputs the password by gazing at the password on the display screen, which includes the following process.

A password input keyboard is displayed on the terminal (the keyboard may be a series of letters, numbers or a target dot array), and the user successively gazes at corresponding positions on the display screen in an order determined based on a preset payment password. When the user gazes at a first position on the display screen (which corresponds to a character of the password input keyboard displayed on the display screen), the terminal collects the eye image of the user and extracts the eye movement feature and the iris feature of the user, and sends the extracted iris feature to the server. The server acquires the calibration coefficient corresponding to the iris feature based on the iris feature, and sends the calibration coefficient to the terminal.

On reception of the calibration coefficient of the user sent by the server, the terminal calculates the coordinates of the position at which the user gazes based on the calibration coefficient, and determines the position at which the user gazes based on the coordinates of the position at which the user gazes, and displays “*”. Alternatively, each time the recognition is completed, a prompt tone is played to prompt the user that the recognition is completed, and a next position can be recognized.

After positions corresponding to the entire passwords are recognized, the password input process is completed, and the terminal sends the password information corresponding to positions gazed by the user to the server. On reception of the password information sent by the terminal, the server compares the password information with a password pre-stored in the database. If the password information is consistent with the password pre-stored in the database, the server sends a payment success prompt to the terminal, and the terminal displays that the payment is successful. If the password information is not consistent with the password pre-stored in the database, the server sends a payment failure prompt to the terminal, and the terminal display that the payment fails.

With the method for authentication according to the embodiment of the present disclosure, the identify authentication is performed on a user based on the eye information acquired when the user gazes at a position point on the screen, and the coordinates of the position point, so as to verify the iris, increase the security of payment and confirm the pay willingness of the user.

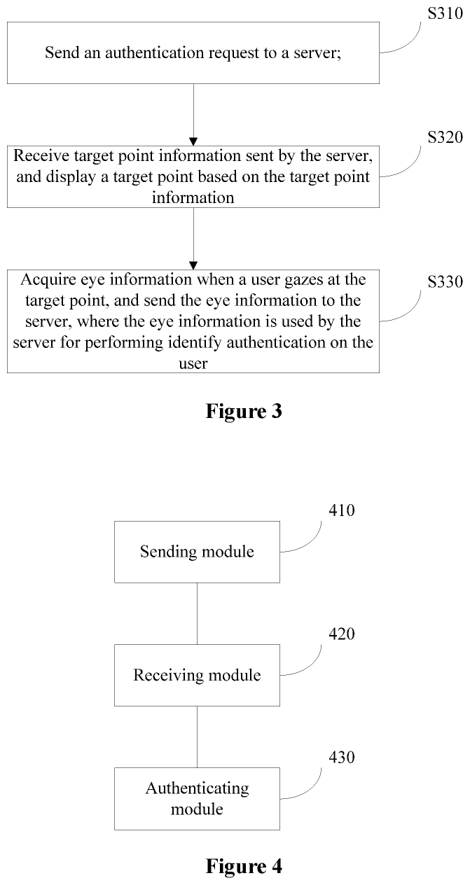

As shown in FIG. 3, a second method for authentication is further provided according to an embodiment of the present disclosure, which is performed by a terminal. The terminal may be a user terminal, or may be a terminal used by a cashier for checkout. The terminal may be a cell phone, a tablet computer, a computer, or the like, and the method includes the following steps S310 to S330.

In step S310, an authentication request is sent to the server.

The authentication request carries the payment amount that needs to be confirmed by the user, the identifier of the terminal, and the user account information.

The above identifier may be a unique code or an IP address of the terminal.

In step S320, the target point information sent by the server is received, and a target point is displayed based on the target point information.

On reception of the authentication request sent by the terminal, the server sends the target point information to the terminal based on the identifier of the terminal, where one piece of target point information may be sent by the server to the terminal, or two or more pieces of target point information may be successively sent by the server to the terminal in chronological order.

The above target point information includes coordinates of the target point on the screen of the terminal.

The above target point may be a point, a number, a letter or a geometric figure.

In an embodiment of the present disclosure, the displaying the target point based on the target point information includes:
determining a position of the target point on the display screen based on a coordinate origin of the terminal display screen and the target point information, and displaying the target point at the position on the terminal.

Optionally, on reception of the target point information sent by the server, the terminal first determines the coordinate origin of the display screen, where the coordinate origin may be an upper left corner, an upper right corner, a lower left corner, a lower right corner of the display screen, or a center point of the screen. After determining the coordinate origin of the display screen, the position of the target point on the display screen is determined based on the coordinate values in the target point information, and the target point is displayed at the corresponding position for the user to gaze at.

Certainly, the above illustrates only a manner for displaying the target point on the display screen. Besides, the target point may be displayed in the following four manners.

1) The target point is displayed on the display screen, and a virtual keyboard is also displayed on the display screen. The target point information refers to a button of the virtual keyboard to be gazed at by the user. In this case, the target point may be a number or a letter on the button, or the position of the button on the keyboard, for example, a row and a column of the keyboard in which the button is located.

2) The target point is displayed on the display screen, and the display screen is divided into multiple regions, and one of the regions serves as the display region of the target point.

3) The target point is a button of a physical keyboard of the terminal. In this case, the target point information may be at least one number or at least one letter, symbol, or the like. The number, letter or symbol is any number, letter or symbol on the physical keyboard. When the terminal receives the above target point information sent by the server, the corresponding number, letter or symbol button on the terminal keyboard can emit light, which instructs the user to gaze at the button.

4) The target point is a button of the physical keyboard of the terminal. In this case, the target point information includes the position of the button on the keyboard to be gazed at by the user, for example, a row and a column of the keyboard in which the button is located. When the terminal receives the above target point information sent by the server, the button at the corresponding position on the keyboard of the terminal emits light, which instructs the user to gaze at the button.

In step S330, the eye information when the user gazes at the target point is acquired, and the above eye information is sent to the server, so that the server performs identity authentication on the user.

In an embodiment, the eye information may be an eye image, or an eye movement feature and an iris feature extracted from the eye image;

In a case that the eye information is an eye image, when the terminal receives the target point information sent by the server, the target point is displayed at a corresponding position on the screen based on the coordinates of the target point in the target point information. In this case, the user is required to gaze at the target point, and when the user gazes at the target point, the eye image of the user when the user gazes at the target point is collected, and the eye image is sent to the server as the eye information.

In a case that the eye information is an eye movement feature and an iris feature extracted from the eye image, when the terminal receives the target point information sent by the server, the target point is displayed at a corresponding position on the screen based on the coordinates of the target point in the target point information. In this case, the user is required to gaze at the target point, and when the user gazes at the target point, the eye image of the user when the user gazes at the target point is collected, and the iris feature and the eye movement feature are extracted from the eye image and sent to server as the eye information.

On reception of the eye information sent by the terminal, the server performs identity authentication on the user based on the eye information and the target point information sent to the terminal. When the identity authentication performed on the user is successful, the user is allowed to perform further operations, for example, to make a payment or to log into an application or an application system.

Optionally, when performing identity authentication on the user, the server first extracts the iris feature of the user and the eye movement feature when the user gazes at the target point from the received eye image. When performing identity authentication on the user, the server first query a database to find an iris feature corresponding to the account information of the user based on the account information of the user, and determines whether the extracted iris feature of the user matches the found iris feature. If the extracted iris feature of the user is consistent with the found iris feature, the eye movement calibration coefficient corresponding to the user account information is acquired from the database, and a result of the identity authentication performed on the user is determined based on the extracted eye movement feature, the eye movement calibration coefficient acquired from the database, and the target point information.

With the method for authentication according to the embodiments of the present disclosure, identify authentication is performed on a user based on the eye information acquired when the user gazes at a position point on the screen, and the coordinates of the position point, so as to verify the iris, increase the security of payment and confirm the pay willingness of the user.

As shown in FIG. 4, an apparatus for authentication is further provided according to an embodiment of the present disclosure, which may be a server configured to perform the first method for authentication according to the embodiment of the present disclosure. The apparatus for authentication includes a sending module 410, a receiving module 420, and an authenticating module 430.

The sending module 410 is configured to acquire, on reception of an authentication request sent by a terminal, target point information, and send the target point information to the terminal, so that the terminal displays a position point to be gazed at by a user on a screen base on the target point information.

The receiving module 420 is configured to receive first eye information acquired by the terminal when the user gazes at the position point.

The authenticating module 430 is configured to perform identity authentication on the user based on the first eye information and the target point information.

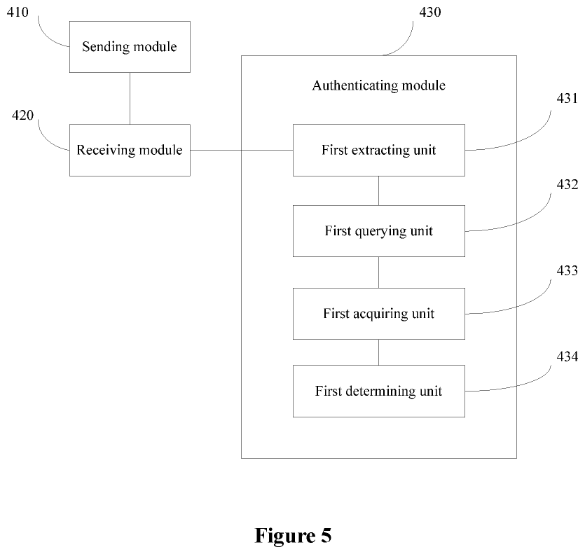

In a case that the first eye information is a first eye image, referring to FIG. 5, the above authenticating module 430 performs identity authentication on the user based on the first eye information and the target point information through a first extracting unit 431, a first querying unit 432, a first acquiring unit 433, and a first determining unit 434.

The first extracting unit 431 is configured to extract an eye movement feature and a first iris feature from the first eye image. The first querying unit 432 is configured to query a database to determine whether the first iris feature is stored in the database. The first acquiring unit 433 is configured to acquire, in a case of determining that the first iris feature is stored in the database, a stored eye movement calibration coefficient matching the first iris feature, where the eye movement calibration coefficient is obtained when a real user registers for an account, and is used for for calibrating an eye movement feature of a user using the account. The first determining unit 434 is configured to determine a result of the identity authentication performed on the user based on the eye movement calibration coefficient, the eye movement feature and the target point information.

The above authentication request carries a second eye image of the user, and the sending module 410 acquires the target point information through a second extracting unit, a second querying unit and a second acquiring unit.

The second extracting unit is configured to extract a third iris feature from the second eye image. The second querying unit is configured to query a database to determine whether the third iris feature is stored in the data base. The second acquiring unit is configured to acquire, in a case of determining that the third iris feature is stored in the database, the target point information.

The acquiring unit acquires the target point information through a selecting subunit, a calculating subunit and a determining subunit.

The selecting subunit is configured to select at least two feature values from the third iris feature, where the third iris feature includes multiple feature values. The calculating subunit is configured to calculate coordinate values of a target point based on the at least two feature values according to a preset rule. The determining subunit is configured to determine the above coordinate values of the target point as the target point information.

In a case that the first eye information includes the first iris feature and the eye movement feature, the above authenticating module 430 performs identity authentication on the user based on the first eye information and the target point information through a third querying unit, a second acquiring unit and a second determining unit.

The third querying unit is configured to query a database to determine whether the first iris feature is stored in the database. The second acquiring unit is configured to acquire, in a case of determining that the first iris feature is stored in the database, a stored eye movement calibration coefficient matching the first iris feature, where the eye movement calibration coefficient is obtained when a real user registers for an account, and is used for for calibrating an eye movement feature of a user using the account; and the first determining unit is configured to determine a result of the identity authentication performed on the user based on the eye movement calibration coefficient, the eye movement feature and the target point information.

In a case that the first eye information is the first eye image, and user account information is carried in the authentication request, the authenticating module 430 performs identity authentication on the user based on the first eye information and the target point information through a third extracting unit, a third acquiring unit, a fourth acquiring unit and a third determining unit.

The third extracting unit is configured to extract an eye movement feature and a first iris feature from the first eye information. The third acquiring unit is configured to acquire a stored second iris feature corresponding to the user account information, and determine whether the second iris feature matches the first iris feature. The fourth acquiring unit is configured to acquire, if the second iris feature matches the first iris feature, a stored eye movement calibration coefficient matching the first iris feature, where the eye movement calibration coefficient is obtained when a real user registers for an account, and is used for calibrating an eye movement feature of a user using the account. The third determining unit is configured to determine a result of the identity authentication performed on the user based on the eye movement calibration coefficient, the eye movement feature and the target point information.

The apparatus for authentication according to an embodiment of the present disclosure further includes:
a prompt information sending module and a recording module.

The prompt information sending module is configured to send prompt information to the terminal in a case of determining that the third iris feature is not stored in the database, to instruct the terminal to prompt the user to register.

The recording module is configured to record the iris feature and the eye movement calibration coefficient of the user on reception of a registration request sent by the terminal.

With the apparatus for authentication according to the embodiment of the present disclosure, the identify authentication is performed on a user based on the eye information acquired when the user gazes at a position point on the screen, and the coordinates of the position point, so as to verify the iris, increase the security of payment and confirm the pay willingness of the user.

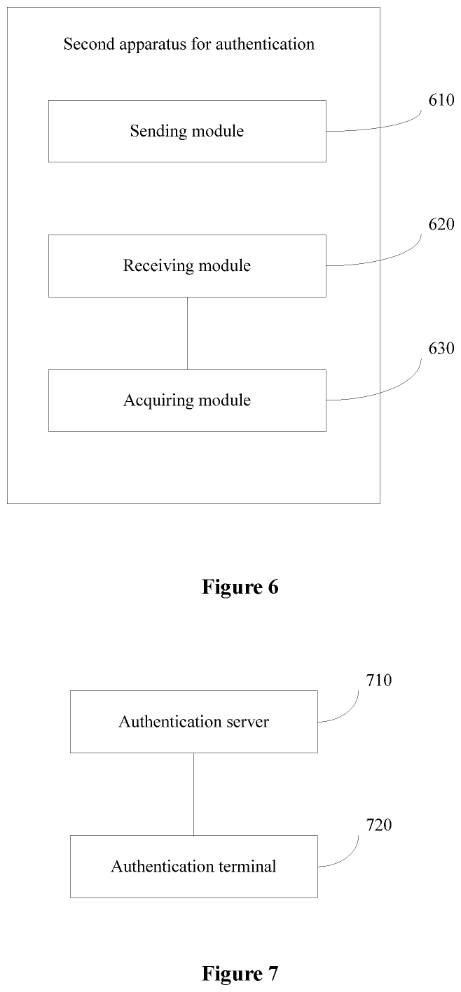

Referring to FIG. 6, a second apparatus for authentication is further provided according to an embodiment of the present disclosure, which may be a terminal configured to perform the second method for authentication according to the embodiment of the present disclosure. The second apparatus for authentication includes a sending module 610, a receiving module 620 and an acquiring module 630;

The sending module 610 is configured to send an authentication request to a server.

The receiving module 620 is configured to receive target point information sent by the server and display a target point based on the target point information.

The acquiring module 630 is configured to acquire eye information when a user gazes at the target point, and send the eye information to the server. The eye information is used by the server for performing identity authentication on the user.

The receiving module 620 displays the target point based on the target point information through a determining unit and a displaying unit.

The determining unit is configured to determine a position of the target point on a display screen of the terminal based on the coordinate origin of the display screen and the target point information. The displaying unit is configured to display the target position at the position of the terminal.

With the apparatus for authentication according to the embodiment of the present disclosure, the identify authentication is performed on a user based on the eye information acquired when the user gazes at a position point on the screen, and the coordinates of the position point, so as to verify the iris, increase the security of payment and confirm the pay willingness of the user.

Referring to FIG. 7, a system for authentication is further provided according to an embodiment of the present disclosure. The system includes an authentication server 710 and an authentication terminal 720.

The above authentication server 710 includes the first apparatus for authentication according to the embodiment of the present disclosure, and the authentication terminal 720 includes the second apparatus for authentication according to the embodiment of the present disclosure.

With the system for authentication according to the embodiment of the present disclosure, the identify authentication is performed on a user based on the eye information acquired when the user gazes at a position point on the screen, and the coordinates of the position point, so as to verify the iris, increase the security of payment and confirm the pay willingness of the user.

The apparatus and the system for authentication according to the embodiments of the present disclosure may be specific hardware on the apparatus or software or firmware installed on the apparatus. The implementation principle and the technical effects of the apparatus and the system provided in the embodiments of the present disclosure are the same as that of the above method embodiments. For a brief description of the apparatus and the system embodiment, parts that are not mentioned may be reference to the content of the above method embodiments. It can be clearly understood by those skilled in the field that, for convenience and concision of the description, the specific operating process of the system, apparatus and unit described above may refer to the corresponding process in the embodiment of the method described above, which is not described herein again.

In the embodiments according the present disclosure, it should be understood that the disclosed apparatus and method may be implemented in other manners. For example, the embodiments of the apparatus described above are only schematic. For example, the division of the units is only a division according to logical function, and there may be other division modes in the practical implementation, for example, multiple units or components may be combined, or integrated into another system; and some features may be ignored or may not be performed. In addition, the coupling between the components, direct coupling or communication connection may be realized by some interfaces, and indirect coupling or communication connection of apparatus or units may be in an electrical, mechanical or other forms.

The above unit described as a separate unit may be or may be not separated physically. The component displayed as a unit may be or may be not a physical unit, that is, may be located at one place or may be distributed on multiple network units. The object of the solution of the embodiment may be achieved by selecting a part or all of the units according to the actual requirements.

In addition, all function units according to the embodiment of the present disclosure may be integrated into one processing unit, or may be a physically separate unit, or may be one unit that is integrated by two or more units.

In a case that the function is implemented in the form of software function unit and is sold or used as a separate product, it can also be stored in a computer readable storage medium. Based on such understanding, the essence, or the part that contributes to the conventional technology of the technical solutions of the present disclosure, or a part of the technical solutions may be embodied in the form of a software product. The computer software product is stored in a storage medium, and includes several instructions configured to allow a computer apparatus (which may be a personal computer, a server, or a network apparatus, and etc.) to execute all or part of the steps of the method of each embodiment of the present disclosure. The storage medium described above includes various media capable of storing program codes, such as a USB flash disk, a movable hard disk, a Read Only Memory (ROM)) a Random Access Memory (RAM), a magnetic disc or an optical disc.

It should be noted that similar reference numerals and letters represents similar items in the following figures. Therefore, once an item is defined in a drawing, it is not necessary to further define and explain it in the subsequent drawings. Moreover, the terms “first”, “second”, “third”, and the like are used merely to distinguish a description, and should not be understood as indicating or implying a relative importance.

Finally, it should be noted that the above examples are specific embodiments of the present disclosure, which are merely provided for illustrating the technical solutions of the present disclosure and are not intend to limit the disclosure, and the protective scope of the present disclosure is not limited to this. Although the present disclosure has been described in detail in reference to the preferred embodiments, those skilled in the art will appreciate that any modifications, variations that are easy to think of, or equivalent substitutions for partial technical features can be made by those skilled in the art in the spirit and scope of the technical solutions of the present disclosure without departing from the protective scope of the present disclosure. The modifications, variations or equivalents do not depart the essence of the corresponding technical solutions from the spirit and scope of the embodiments of the present disclosure. All of those should fall into the protective scope of the present disclosure. Therefore, the scope of the present disclosure should be defined by the scope of the claims.

### INDUSTRIAL APPLICABILITY

As can be seen from the above description, according to the embodiments of the present disclosure, the identify authentication is performed on a user based on the eye information acquired when the user gazes at a position point on the screen, and the coordinates of the position point, so as to verify the iris, increase the security of payment and confirm the pay willingness of the user.

1. A method for authentication, comprising:
acquiring, on reception of an authentication request sent by a terminal, target point information, and sending the target point information to the terminal, so that the terminal displays a position point to be gazed at by a user on a screen base on the target point information;
receiving first eye information acquired by the terminal when the user gazes at the position point; and
performing identity authentication on the user based on the first eye information and the target point information.

2. The method according to claim 1, wherein in a case that the first eye information is a first eye image, the performing identity authentication on the user based on the first eye information and the target point information comprises:
extracting an eye movement feature and a first iris feature from the first eye information,
querying a database to determine whether the first iris feature is stored in the database,
acquiring, in a case of determining that the first iris feature is stored in the database, a stored eye movement calibration coefficient matching the first iris feature, wherein the eye movement calibration coefficient is obtained when a real user registers for an account, and is used for calibrating an eye movement feature of a user using the account, and
determining a result of the identity authentication performed on the user based on the eye movement calibration coefficient, the eye movement feature and the target point information.

3. The method according to claim 1, wherein in a case that the first eye information is a first eye image and the authentication request carries user account information, the performing identity authentication on the user based on the first eye information and the target point information comprises:
extracting an eye movement feature and a first iris feature from the first eye information,
acquiring a stored second iris feature corresponding to the user account information, and determining whether the second iris feature matches the first iris feature,
acquiring, in a case of determining that the second iris feature matches the first iris feature, a stored eye movement calibration coefficient matching the first iris feature, wherein the eye movement calibration coefficient is obtained when a real user registers for an account, and is used for calibrating an eye movement feature of a user using the account, and
determining a result of the identity authentication performed on the user based on the eye movement calibration coefficient, the eye movement feature and the target point information.

4. The method according to claim 1, wherein in a case that the first eye information comprises a first iris feature and an eye movement feature, the performing identity authentication on the user based on the first eye information and the target point information comprises:
querying a database to determine whether the first iris feature is stored in the database,
acquiring, in a case of determining that the first iris feature is stored in the database, a stored eye movement calibration coefficient matching the first iris feature, wherein the eye movement calibration coefficient is obtained when a real user registers for an account, and is used for calibrating an eye movement feature of a user using the account, and
determining a result of the identity authentication performed on the user based on the eye movement calibration coefficient, the eye movement feature and the target point information.

5. The method according to claim 1, wherein the authentication request carries second eye information of the user, and in a case that the second eye information is a second eye image, the acquiring target point information comprises:
extracting a third iris feature from the second eye information,
querying a database to determine whether the third iris feature is stored in the database, and
acquiring, in a case of determining that the third iris feature is stored in the database, the target point information.

6. The method of claim 5, wherein the acquiring the target point information comprises:
selecting at least one feature value from the third iris feature, wherein the third iris feature comprises a plurality of feature values,
calculating coordinate values of a target point based on the at least one feature value according to a preset rule, and
determining the coordinate values of the target point as the target point information.

7. The method according to claim 5, further comprising:
sending, in a case of determining that the third iris feature is not stored in the database, prompt information to the terminal to instruct the terminal to prompt the user to register; and
recording, on reception of a registration request sent by the terminal, the iris feature and the eye movement calibration coefficient of the user.

8. A method for authentication, comprising:
sending an authentication request to a server;
receiving target point information sent by the server, and displaying a target point based on the target point information; and
acquiring eye information when a user gazes at the target point, and sending the eye information to the server, wherein the eye information is used by the server for performing identify authentication on the user.

9. The method according to claim 8, wherein the displaying a target point based on the target point information comprises:
determining a position of the target point on a display screen based on a coordinate origin of the display screen and the target point information, and
displaying the target point at the position on the display screen.

10. An apparatus for authentication for performing the method according to claim 1, comprising:
a sending module, configured to acquire, on reception of an authentication request sent by a terminal, target point information, and send the target point information to the terminal, so that the terminal displays a position point to be gazed at by a user on a screen base on the target point information;
a receiving module, configured to receive first eye information acquired by the terminal when the user gazes at the position point; and
an authenticating module, configured to perform identity authentication on the user based on the first eye information and the target point information.

11. The apparatus according to claim 10, wherein in a case that the first eye information is a first eye image, the authenticating module comprises:
a first extracting unit, configured to extract an eye movement feature and a first iris feature from the first eye image,
a first querying unit, configured to query a database to determine whether the first iris feature is stored in the database,
a first acquiring unit, configured to acquire, in a case of determining that the first iris feature is stored in the database, a stored eye movement calibration coefficient matching the first iris feature, wherein the eye movement calibration coefficient is obtained when a real user registers for an account, and is used for calibrating an eye movement feature of a user using the account, and
a first determining unit, configured to determine a result of the identity authentication performed on the user based on the eye movement calibration coefficient, the eye movement feature and the target point information.

12. The apparatus according to claim 10, wherein the authentication request carries second eye information of the user, and in a case that the second eye information is a second eye image, the sending module comprises:
a second extracting unit, configured to extract a third iris feature from the second eye information,
a second querying unit, configured to query a database to determine whether the third iris feature is stored in the database, and
a sending unit, configured to acquire, in a case of determining that the third iris feature is stored in the database, the target point information.

13. An apparatus for authentication, for performing the method according to claim 8, comprising:
a sending module, configured to send an authentication request to a server;
a receiving module, configured to receive target point information sent by the server and display a target point based on the target point information; and
an acquiring module, configured to acquire eye information when a user gazes at the target point, and send the eye information to the server, wherein the eye information is used by the server for performing identify authentication on the user.

14. A system for authentication, comprising an authentication server and an authentication terminal, wherein
the authentication server comprises:
a sending module, configured to acquire, on reception of an authentication request sent by a terminal, target point information, and send the target point information to the terminal, so that the terminal displays a position point to be gazed at by a user on a screen base on the target point information,
a receiving module, configured to receive first eye information acquired by the terminal when the user gazes at the position point, and
an authenticating module, configured to perform identity authentication on the user based on the first eye information and the target point information, and
the authentication terminal comprises:
a sending module, configured to send an authentication request to a server,
a receiving module, configured to receive target point information sent by the server and display a target point based on the target point information, and
an acquiring module, configured to acquire eye information when a user gazes at the target point, and send the eye information to the server, wherein the eye information is used by the server for performing identify authentication on the user.

15. The system for authentication according to claim 14, wherein in a case that the first eye information is a first eye image, the authenticating module comprises:
a first extracting unit, configured to extract an eye movement feature and a first iris feature from the first eye image,
a first querying unit, configured to query a database to determine whether the first iris feature is stored in the database,
a first acquiring unit, configured to acquire, in a case of determining that the first iris feature is stored in the database, a stored eye movement calibration coefficient matching the first iris feature, wherein the eye movement calibration coefficient is obtained when a real user registers for an account, and is used for calibrating an eye movement feature of a user using the account, and
a first determining unit, configured to determine a result of the identity authentication performed on the user based on the eye movement calibration coefficient, the eye movement feature and the target point information.

16. The system for authentication according to claim 14, wherein the authentication request carries second eye information of the user, and in a case that the second eye information is a second eye image, the sending module comprises:
a second extracting unit, configured to extract a third iris feature from the second eye information,
a second querying unit, configured to query a database to determine whether the third iris feature is stored in the database, and
a sending unit, configured to acquire, in a case of determining that the third iris feature is stored in the database, the target point information.
